(19) United States
(12) Patent Application Publication
(10) Pub. No.: US 2010/0060923 A1
(43) Pub. Date: Mar. 11, 2010

(54) APPARATUS, METHOD AND PROGRAM

(75) Inventor: Naoya Kakutani, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/547,707

(22) Filed: Aug. 26, 2009

(30) Foreign Application Priority Data
Sep. 9, 2008 (JP) 2008-231414
Apr. 2, 2009 (JP) 2009-090172

(51) Int. Cl. G06F 15/00

(52) U.S. Cl. 358/1.14

(57) ABSTRACT

An object of the present invention is to provide an image processing apparatus which can efficiently perform detection and decode processing carried out in parallel for a plurality of kinds of codes. For achieving the above object, an apparatus according to the present invention is an information processing apparatus capable of causing a printing unit to print a first code that can include both of copy prohibition information and copy permission information and a second cod that can include only the copy prohibition information of the copy prohibition information and the copy permission information, wherein the copy prohibition information is included in the first code, when the first code is printed together with the second code by the printing unit.

### BACKGROUND OF THE INVENTION

1. Field of the Invention

The present invention relates to an apparatus, a method, and a program which can prevent unauthorized copy of a document.

2. Description of the Related Art

A method for preventing unauthorized copy of a document is proposed as follows. First, in creating a document, a copy condition is embedded in the document as image data indicating whether the document is “copy-prohibited” or not, and then the document is printed. On the other hand, in copying the document, a copying machine detects the copy condition from the printed document, and controls copy operation (executes the copy operation or interrupts the copy operation) according to the copy condition.

For such a method, Japanese Patent Laid-Open No. 2002-305646 discloses a method in which a confidential level of the document is detected and the copy operation is controlled according to the confidential level, when the copy machine detects a barcode from the document to be copied. By this method, it is possible to determine whether or not the document is a document requiring the control of the copy operation, only by determining whether or not the barcode is embedded in the document to be copied.

Further, Japanese Patent Laid-Open No. H10-312447(1998) discloses a method of using a two-dimensional code such as QR code (registered trade mark) which is used universally as the code embedded in the document.

The barcode such as one disclosed in Japanese Patent Laid-Open No. 2002-305646 has low visibility and does not reduce readability of the image data considerably even when the barcode is added to the whole image data. Further, since the barcode is added over the whole document, the barcode has a strong resistance against falsification. However, the barcode has not been used universally compared to the two-dimensional code disclosed in Japanese Patent Laid-Open No. 10-312447, and a copy machine which can read the barcode or embed the barcode into the document is limited.

On the other hand, since the two-dimensional code is being used universally, a copy machine which can treat the two-dimensional code exists widely. In addition, the two-dimensional code is a rectangular code and has a high visibility in itself, and thereby damages the readability of the original image data when the two-dimensional code is added over the whole image data. Accordingly, the two-dimensional code is generally added to a part of the image data. However, since the two-dimensional code is added only to a part of the image data, information of the two-dimensional code is lost when the part is masked and has a weak resistance against falsification compared to the barcode.

Meanwhile, since the barcode has a unique specification, the specifications of the barcodes are different among copy machine makers, for example, and there is a limitation that the barcode cannot be used commonly among the copy machines of the respective makers. However, generally, there is a case in which the copy machines of multiple makers exist in an office or a case in which the document is input from the outside. Accordingly, there exists a case in which the unique barcode, which has the low visibility and is strong against the falsification, and the two-dimensional code such as QR code (registered trade mark), which can be treated universally, are treated at the same time.

Therefore, the copy machine sometimes carries out detection and decoding of plural kinds of codes for handling the plural kinds of codes such as the barcode and the two-dimensional code.

When the copy machine carries out the detection and decoding of the plural kinds of codes by scanning the document, the copy machine does not know which kind of code is added preliminarily to the document, and thereby the copy machine carries out detection processing of the plural kinds of codes. Further, the copy machine is required to carry out the detection and decoding processing of the plural kinds of codes in parallel for avoiding decrease in the copy productivity of the copy machine.

However, time required for the detection and decoding processing is different depending on the kind of code. Accordingly, when the detection and decoding processing of one kind of code is completed but the detection and decoding processing of the other kind of code is not completed, the copy machine cannot move to the next processing and the productivity of the copy machine is decreased.

Accordingly, the present invention aims at efficiently performing the detection and decoding processing carried out in parallel for the plural kinds of codes.

### SUMMARY OF THE INVENTION

For solving the above problem, an apparatus according to the present invention is an information processing apparatus capable of causing a printing unit to print a first code that can include both of copy prohibition information and copy permission information and a second code that can include only the copy prohibition information of the copy prohibition information and the copy permission information, wherein the copy prohibition information is included in the first code when the first code is printed together with the second code by the printing unit.

According to the present invention, it is possible to efficiently perform the detection and decoding processing carried out in parallel for the plural kinds of codes.

Further features of the present invention will become apparent from the following description of exemplary embodiments (with reference to the attached drawings).

### BRIEF DESCRIPTION OF THE DRAWINGS

FIG. 1 is a diagram showing an example of a printed material including an LVBC;

FIG. 2 is a diagram showing an example of a printed material including a two-dimensional code;

FIG. 3 is a diagram showing an example of a printed material including an LVBC and a two-dimensional code;

FIG. 4 is a diagram showing an example of a print setting screen provided by a printer driver;

FIG. 5 is a block diagram showing the inside of an image processing apparatus;

FIG. 6 is a diagram showing additional information to be embedded in an LVBC information pattern;

FIG. 7 is a diagram showing an example of a manner how a data dot and an arrangement dot are disposed;

FIG. 8 is a diagram showing how a dot is rotated;

FIG. 9 is a diagram showing a tile and a tiling arrangement;

FIG. 10 is a diagram showing an example of a dialog box;

FIG. 11 is a flowchart showing an example of a flow in copy control carried out by an image processing apparatus;

FIG. 12 is a flowchart showing an example of a flow in copy control carried out by an image processing apparatus;

FIG. 13 is a diagram showing an example of information embedded in a two-dimensional code; and

FIG. 14 is a diagram showing an example of a dialog box.

### DESCRIPTION OF THE EMBODIMENTS

Hereinafter, an embodiment according to this invention will be described exemplarily in detail with reference to the drawings. Note that a relative position of a constituent, a formula, a numerical value, etc., which are described in this embodiment, do not limit the scope of this invention only to those in the embodiment as far as a specific description is not added in particular.

### Embodiment 1

The present embodiment assumes that an image processing apparatus treats two kinds of codes, a first code and a second code, for preventing unauthorized copying.

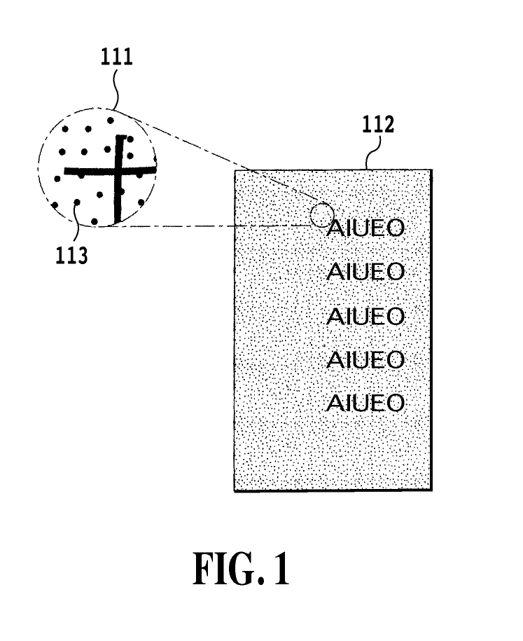

FIG. 1 is a diagram showing an appearance of a printed material 112 including the first code embedded with additional information. In the present embodiment, this first code is called an LVBC (Low Visibility Barcode).

In FIG. 1, the region 111 shows an enlarged part of the printed material 112. The region 111 shows a part of a character (a part of Japanese character “A”) printed on the printed material 112 and an LVBC 113.

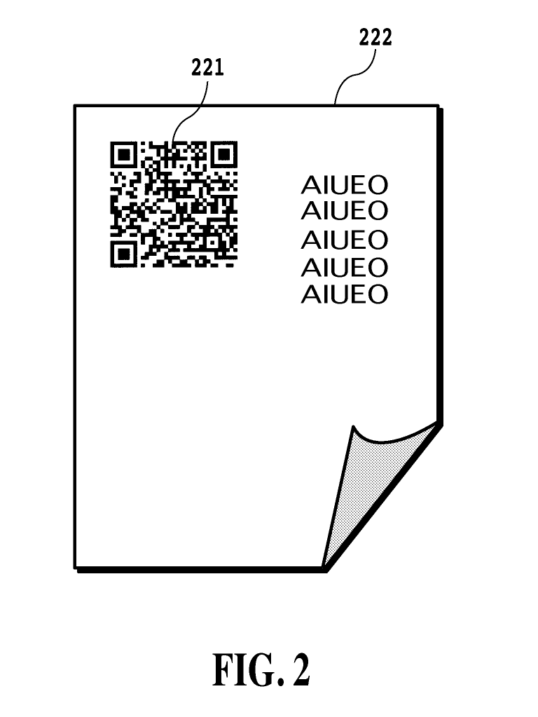

FIG. 2 shows an appearance of a printed material including the two-dimensional code as the second code embedded with additional information. In FIG. 2, a two-dimensional code 221 is printed at the upper left of a printed material 222. Here, the position where the two-dimensional code 221 is printed and the size and number of the two dimensional codes 221 are optional. Further, while QR code (registered trade mark) is shown as the two-dimensional code in the drawings used for explaining the present invention, the two-dimensional code except QR code (registered trade mark) may be used.

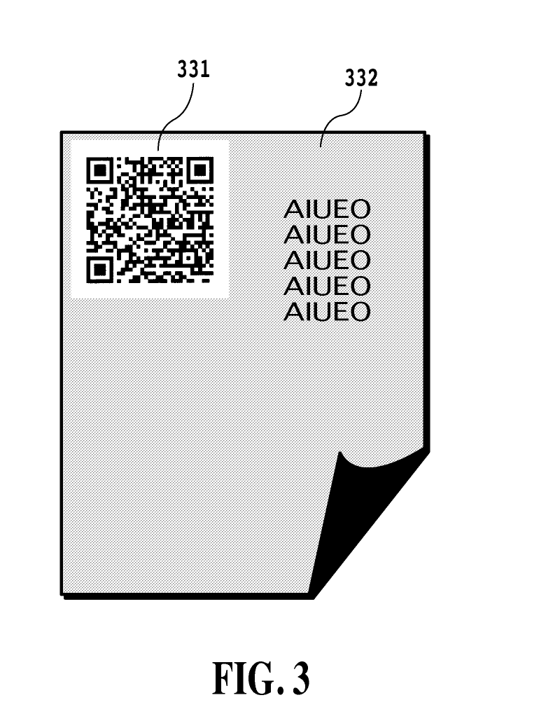

FIG. 3 shows an appearance of a printed material including the LVBC and the two-dimensional code. In FIG. 3, a two-dimensional code 331 is printed at the upper left of a printed material 332. Here, the position where the two-dimensional code 331 is printed and the size and number of the two-dimensional codes 331 are optional.

The image processing apparatus according to the present embodiment scans and copies the printed materials 112, 222, and 332 shown in FIG. 1 to FIG. 3.

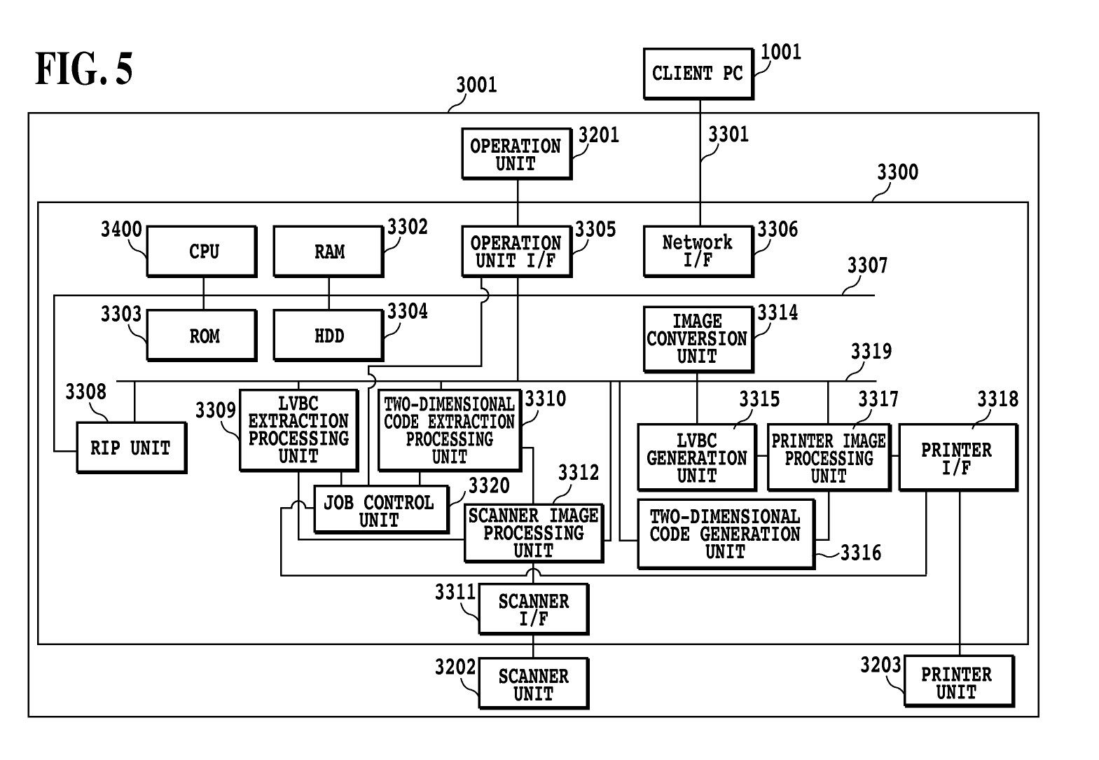

FIG. 5 is a block diagram showing the inside of an image processing apparatus 3001.

A controller 3300 controls a scanner unit 3202 and a printer unit 3203. Further, the controller 3300 controls data communication between a client PC 1001 and the image processing apparatus 3001 via a LAN or WAN 3301.

A RAM 3302 in FIG. 5 is a system work memory for the operation of a CPU 3400 and also a memory for temporarily storing document image data received by the image processing apparatus 3001.

A ROM 3303 stores a boot program and the like of the image processing apparatus 3001.

An HDD 3304 is a hard disc drive and stores system software of the image processing apparatus 3001 and the document image data received by the image processing apparatus 3001.

An operation unit I/F 3305 is an interface unit for connecting a system bus 3307 and an operation unit 3201 to each other. The operation unit I/F 3305 receives the document image data to be displayed on the operation unit 3201 from the system bus 3307, and outputs the document image data to the operation unit 3201 and also outputs information input from the operation unit 3201 to the system bus 3307.

A network I/F 3306 is an interface board connecting the LAN or WAN 3301 and the system bus 3307 to each other.

An image bus 3319 is a transmission path for exchanging the document image data and configured by the PCI bus or IEEE 1394.

A scanner image processing unit 3312 transfers the document image data received from the scanner unit 3202 via the scanner I/F 3311 to an LVBC extraction processing unit 3309 and a two-dimensional code extraction processing unit 3310.

The LVBC extraction processing unit 3309 carries out detection and decoding of the additional information for the LVBC added to the document image data. Details will be described hereinafter for the contents of the additional information embedded in this LVBC and for the detection and decoding processing of the additional information by the LVBC extraction processing unit 3309.

The two-dimensional code extraction processing unit 3310 carries out detection and decoding of the additional information for the two-dimensional code added to the document image data. Details will be described hereinafter for the contents of the additional information embedded in this two-dimensional code and for the detection and decoding processing of the additional information by the two-dimensional code extraction processing unit 3310. Further, this detection and decoding is carried out by the CPU 3400 of the controller according to a control program stored in the ROM 3303 or the HDD 3304.

Here, in the case that a computation cost of the detection and decoding of the LVBC is high, the detection and decoding of the LVBC may not be carried out using the CPU 3400 of the image processing apparatus and instead the detection and decoding of the LVBC may be carried out by other hardware. In such a case, the hardware for carrying out the detection and decoding of the LVBC (hardware decoder) may be an FPGA, an ASIC, or a PPC, for example.

On the other hand, the detection and decoding of the two-dimensional code generally needs a lower computation cost and thereby may be carried out by software on the CPU 3400 (software decoder) or may be carried out by the above other hardware.

A printer image processing unit 3317 performs image processing on the document image data referring to attribute data accompanying the received document image data.

An LVBC generation unit 3315 generates the LVBC embedded with the additional information. Then, the printer image processing unit 3317 adds this LVBC to the document image data. This LVBC addition processing by the printer image processing unit 3317 is carried out by the CPU 3400 of the controller 3300 according to the control program stored in the RON 3303 or the HDD 3304.

A two-dimensional code generation unit 3316 generates the two-dimensional code embedded with the additional information. Then, the printer image processing unit 3317 adds this two-dimensional code to the document image data. This two-dimensional code addition processing by the printer image processing unit 3317 is carried out by the CPU 3400 of the controller 3300 according to the control program stored in the ROM 3303 or the HDD 3304.

An image conversion unit 3314 performs predetermined conversion processing such as rotation, color-space conversion, binary to multi-value conversion, image synthesis, and thinning-out on the document image data.

A RIP unit 3308 receives intermediate data generated from PDL code data transmitted from the client PC 1001 and generates bit map data. The generated bit map data is transmitted to the image bus 3319.

The operation of the image processing apparatus 3001 will be described in detail with reference to FIG. 5.

After a user has placed a document on a document feeder and the operation unit 3201 has received a copy start instruction from the user, the scanner unit 3202 starts to read the document. The scanner unit 3202 sends the read document image data to the scanner image processing unit 3312 via the scanner I/F 3311. Then, the scanner image processing unit 3312 sends the received document image data to the LVBC extraction processing unit 3309 and the two-dimensional code extraction processing unit 3310.

The LVBC extraction processing unit 3309 performs the detection and decoding processing of the LVBC on the received document image data.

Further, the two-dimensional code extraction processing unit 3310 performs the detection and decoding of the two-dimensional code on the received document image data.

Note that the above detection and decoding processing of the LVBC and the detection and decoding processing of the two-dimensional code are carried out in parallel.

Then, the LVBC extraction processing unit 3309 and the two-dimensional code extraction processing unit 3310 send the extraction results to a job control unit 3320.

The job control unit 3320 determines whether to execute or interrupt copy operation according to the received extraction results. Here, the job control unit 3320 determines whether to execute or interrupt the copy operation according to a decoding result in either one of the LVBC extraction processing unit 3309 and the two-dimensional code extraction processing unit 3310.

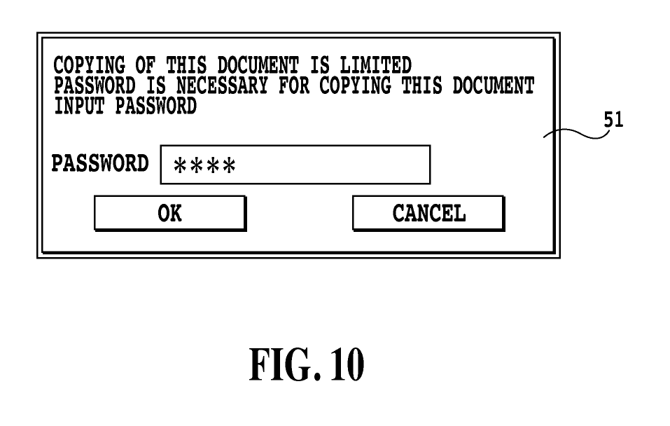

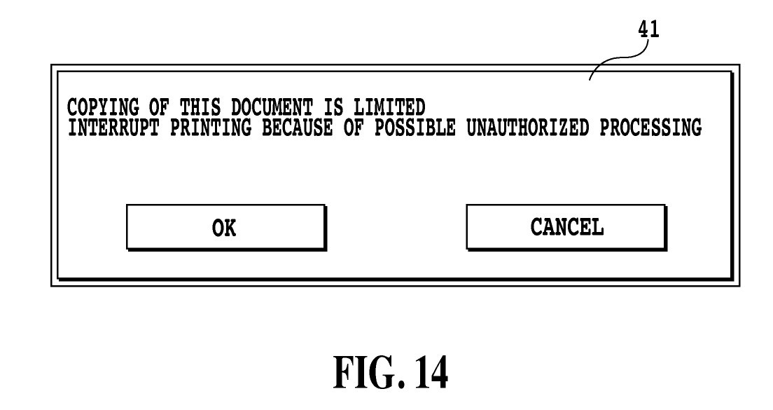

When the job control unit 3320 determines to interrupt the copy operation, the job control unit 3320 sends a copy operation interruption order to the printer unit 3203 via a printer I/F 3318. Further, the job control unit 3320 controls the operation unit I/F 3305 and displays a dialog box 41 shown in FIG. 14 or a dialog box 51 shown in FIG. 10 on the operation unit 3201.

Note that the printer unit 3203 interrupts printing even during printing, when having received the copy operation interruption order from the job control unit 3320.

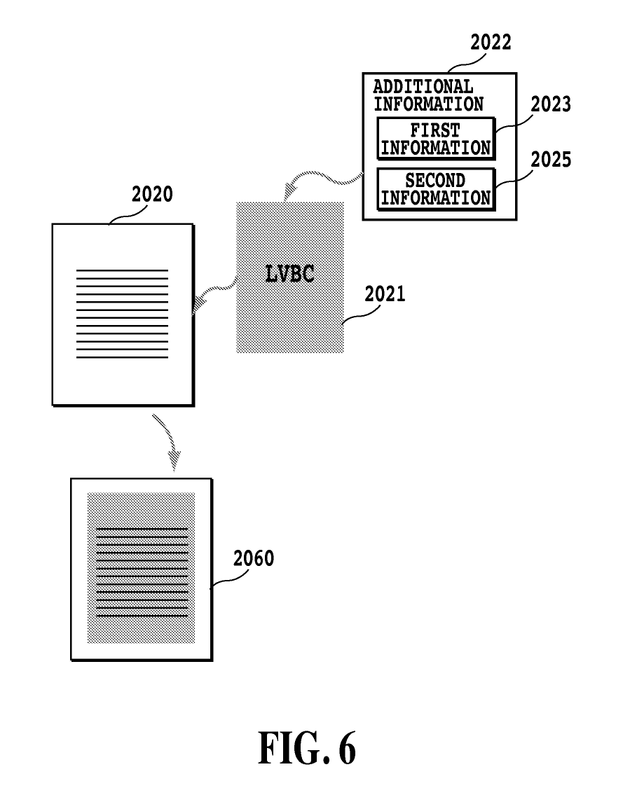

Next, the processing contents executed by the image processing apparatus 3001 will be described in detail with reference to FIG. 5 and FIG. 6.

The client PC 1001 generates print data when having received the print operation instruction of the document image data from the user. Then, the client PC 1001 transmits the print data to the image processing apparatus 3001 via the LAN or WAN 3301.

The image processing apparatus 3001 converts the received print data into the document image data and prints the document image data on a sheet as the printed material.

Here, the client PC 1001 receives an instruction for adding both of or either one of the LVBC and the two-dimensional code to the document image data from the user together with the instruction of print operation. Then, the image processing apparatus 3001 carries out a setting for adding both of or either one of the LVBC and the two-dimensional code to the document image data. Subsequently, the image processing apparatus 3001 adds both of or either one of the LVBC and the two dimensional code according to the setting.

FIG. 6 is a diagram showing additional information 2022 to be embedded in an LVBC information pattern 2021. The additional information 2022 includes first information 2023 and second information 2025 as encoded information.

In the present embodiment, for example, the first information 2023 is assumed to be copy control information and the second information 2205 is assumed to be tracking information having a print job history.

The information pattern 2021 of the LVBC is a pattern in which the LVBC generation unit 3315 converts the additional information 2022 into an image.

In the present embodiment, a channel of the first information 2023 corresponds to an LDD channel to be described hereinafter. Since the first information 2023 is detected in the following scan operation and used as copy control information which controls the printing of the image data obtained by scanning, the first information 2023 is required to be detected in a high speed.

In the present embodiment, the second information 2025 includes information for tracking a person who prints the printed material 2060. The tracking information includes information about the printing such as a print date and time, a user name of a user who instructed a printing, and a device name, for example. A channel of the second information 2025 corresponds to an HDD channel to be described hereinafter.

By using the LVBC, it is possible to embed a synthesis of the first information 2023 and the second information 2025 in the image as the additional information. Further, the LVBC can be extracted by selecting either one of the extraction of only the first information 2023, the extraction of only the second information 2025, and the extraction of the first information 2023 and the second information 2025, according to an application state. The embedding method and the extraction method of the additional information using the LVBC will be described hereinafter.

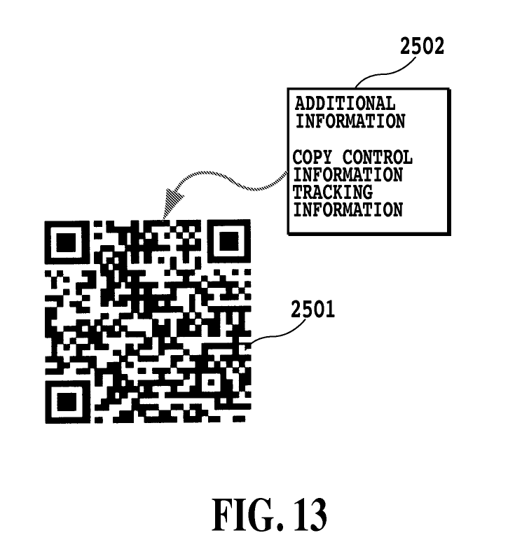

FIG. 13 is a diagram showing an example of the information to be embedded in a two-dimensional code 2501. In the present embodiment, the two-dimensional code is configured with the copy control information and the tracking information. By using the two-dimensional code, it is possible to embed a synthesis of these sets of information in the image as additional information 2502.

When the user tries to copy the printed material embedded with both of or either one of the LVBC and the two-dimensional code using the image processing apparatus 3001, the image processing apparatus 3001 detects that the code is embedded in the printed material. Then, the image processing apparatus 3001 controls the copy operation according to the copy condition included in the copy control information of the additional information. For example, if the copy condition is “prohibit copy”, the image processing apparatus 3001 interrupts the copy operation. Thereby, it is possible to prevent the copy of the printed material which is prohibited from being copied.

Next, details will be described for the setting processing of the copy control information in the client PC 1001 and the copy operation control in the image processing apparatus 3001.

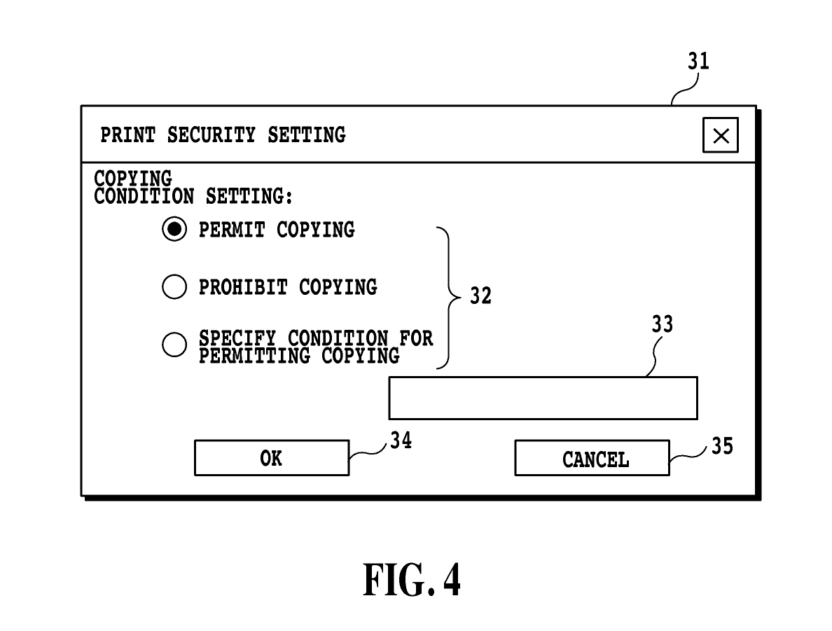

FIG. 4 shows an example of a print setting screen provided by a printer driver installed in the client PC 1001.

The user sets the copying condition using a print security setting dialog box 31. The user selects one condition among conditions; “permit copying”, “prohibit copying”, and “specify a condition for permitting copying”, by putting a check mark into a radio button 32 within the print security setting dialog box 31. The selected condition is embedded in the document to be printed as the copy control information. If “specify a condition for permitting copying” is selected, a condition information input field 33 becomes a state available for input, and the user inputs the condition information therein. This condition information is also embedded in the document to be printed as the copy control information. The condition information includes a pass word, for example. Meanwhile, when the user tries to copy the printed material embedded with “specify a condition for permitting copying”, using the image processing apparatus 3001, the image processing apparatus 3001 prompts the user to input the condition information. In this case, the user is permitted to copy the printed material, if the user inputs the condition information which has been input in the condition information input field 33 in the print setting, into the image processing apparatus 3001. Note that the condition information may be a name of a user who is permitted to copy the printed material. Further, the condition information may be a copy-permitted period (e.g., Jan. 1, 2009 to Jan. 31, 2009). When the copy-permitted period is set for the condition information, the image processing apparatus 3001 carries out control of permitting the copying only during the period.

Note that, in the case that the user provides the instruction of embedding the copy control information “prohibit copying”, the present printer driver embeds both of the LVBC and the two-dimensional barcode in the document image data. At this time, the information “prohibit copying” is embedded in both of the codes. That is, for the document image data, the LVBC including the information prohibiting the copying is synthesized and also the two-dimensional barcode including the information prohibiting the copying is synthesized. On the other hand, in the case that the user indicates the information “permit copying” or “specify a condition for permitting copying”, only the LVBC is embedded in the document image data. This is because the information “permit copying” or “specify a condition for permitting copying” cannot be embedded in the two-dimensional code. Note that, if the two-dimensional code is designed so as to enable the information “permit copying” to be embedded, it becomes possible to embed not only the LVBC but also the two-dimensional code when the user provides the instruction of “permit copying” (variation of the present embodiment). However, it is not preferable to design the two-dimensional code which enables the information “specify a condition for permitting copying” to be embedded. The reason is that the size of the two-dimensional code becomes large as described above. The two-dimensional code has a dark image differently from the LVBC and thereby it is not preferable to synthesize the image of the two-dimensional code in an image area of the document image data (area including contents such as a character). Therefore, it is a problem that this size of the two-dimensional code becomes large. Anyway, in the present embodiment, although both of the LVBC and the two-dimensional code may be synthesized according to the user's instruction, the information sets included in both of the synthesized codes are designed to be the same as each other.

Next, FIG. 14 and FIG. 10 show examples of a dialog box to be presented to the user by the image processing apparatus 3001 which has detected that the copy condition “prohibit copying” or “specify a condition for permitting copying” is embedded in the printed material to be copied as the copy control information. These dialog boxes are displayed on the operation unit 3201 of the image processing apparatus 3001. FIG. 14 shows the dialog box 41 displayed on the operation unit 3201 when the user tries to copy the printed document in which “prohibit copying” is embedded as the copy control information. The image processing apparatus 3001 notifies the user of a message that the copying is not carried out, when having detected that the copy control information indicating “prohibit copying” is embedded in the printed document to be copied. Accordingly, the user gives up the copying when having received this notification.

FIG. 10 shows the dialog box 51 displayed on the operation unit 3201, when the user tries to copy the document in which the copy control information indicating “specify a condition for permitting copying” is embedded as the copy control information. The image processing apparatus 3001, when having detected that the copy control information indicating “specify a condition for permitting copying” is embedded in the printed document to be copied, notifies the user of a message that a password input is necessary for the copying of this document. The user, when having received this notification, inputs the password by using a keyboard of the operation unit 3201, IC card, or the like. Subsequently, the image processing apparatus 3001 collates the password embedded in the printed document as the copy control information and the password input by the user with each other, and executes the copy operation if both of the passwords meet each other. On the other hand, if both of the passwords do not meet each other and the password authentication has failed, the dialog box 41 shown in FIG. 14 is displayed on the operation unit 3201.

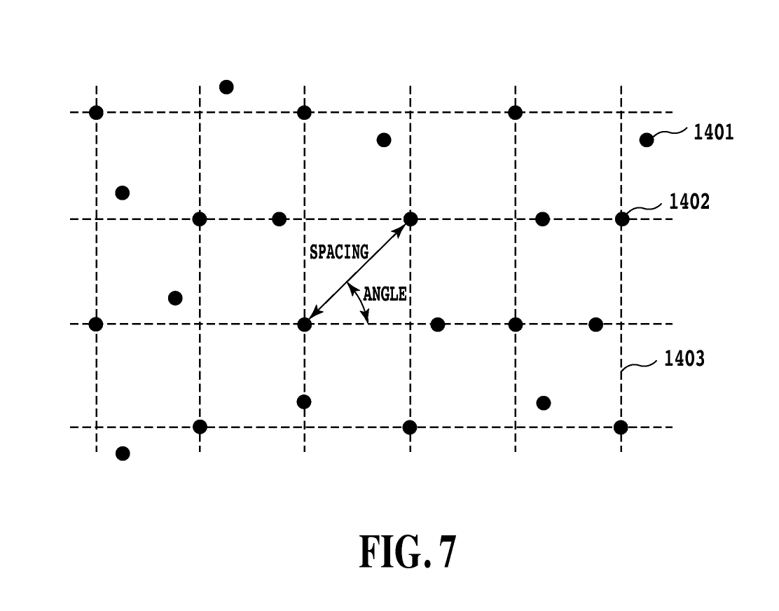

Next, an example of the embedding method will be described using FIGS. 7 to 9 for the case that the LVBC generation unit 3315 embeds the first information 2023 and the second information 2025 in the printed material 2060 at the printing. Obviously, the method of embedding the first information 2023 and the second information 2025 in the printed material 2060 is not limited to the following method, and another method may be used.

FIG. 7 shows an example of a manner how to dispose a data dot 1401 and an arrangement dot 1402 in the LVBC.

A reference grid 1403 is formed by the arrangement dot. Then, the data dot 1401 is adjusted against the reference grid 1403.

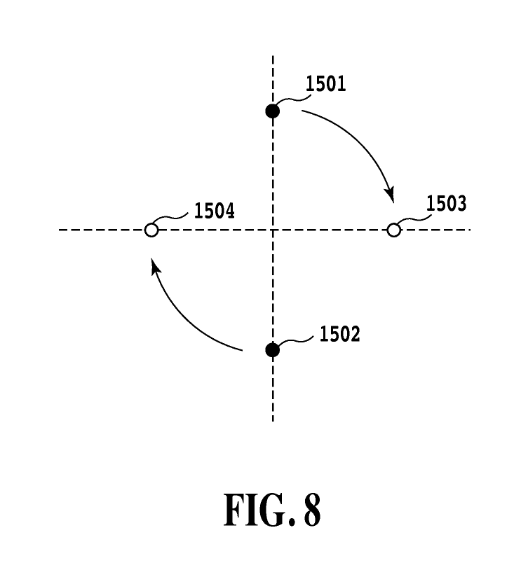

FIG. 8 is a diagram showing how the dot is rotated.

As shown in FIG. 8, the dots 1501 and 1502 are rotated by 90 degrees for calculation of the coordinates 1503 and 1504, respectively.

In the present embodiment, the two channels of the data such as the first information 2023 and the second information 2025 are stored at the same time for one LVBC information pattern 2021.

The additional information 2022 is tiled repeatedly over the whole grid when embedded in the LVBC.

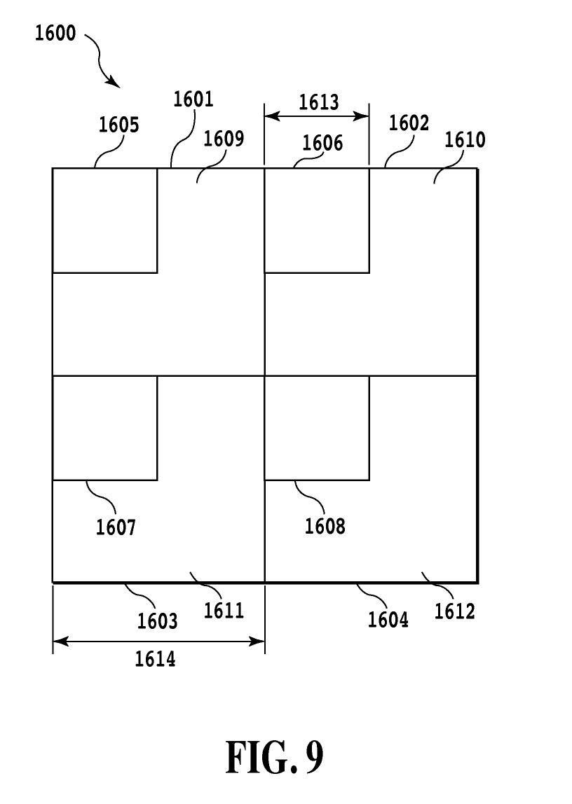

FIG. 9 shows a unique single tile 1600 and a tiling arrangement.

The tile 1600 is configured with two kinds of channels, a high density data channel (HDD channel) and a low density data channel (LDD channel). The HDD channel has a low robustness, while the LDD channel has a high robustness. In addition, the tile 1600 is composed of four sub-tiles 1601 to 1604 which are the HDD channel tiles.

Each of the HDD channel tiles is a square grid having a size of an HDD tile size 1614 which is based on a unit of a grid cell or the data dot. Each of the HDD channel tiles includes one smaller embedding tile called an LDD channel tile. The LDD channel tile of the tile 1600 is composed of the sub-tiles 1605 to 1608. This means that the tile 1600 includes four copies of the LDD channel tile.

Each of the LDD channel tiles is a square grid having a size of an LDD tile size 1613 which is based on a unit of the grid cell or the data dot. In addition, the HDD channel occupies entire areas of the four HDD channel tiles except the LDD channel tiles. Then, this means that the tile 1600 includes only a single copy of the HDD channel. The areas 1609 to 1612, for example, form the HOD channel collectively.

The number of HDD channel tiles which are used for storing the HDD channel can be increased as needed.

An error correction code (ECC) is applied to the data for both of the LDD and HDD channels. In the present embodiment, a low density parity check (LDPC) code is used for the ECC. The LDPC is a high performance ECC and a publicly known technique.

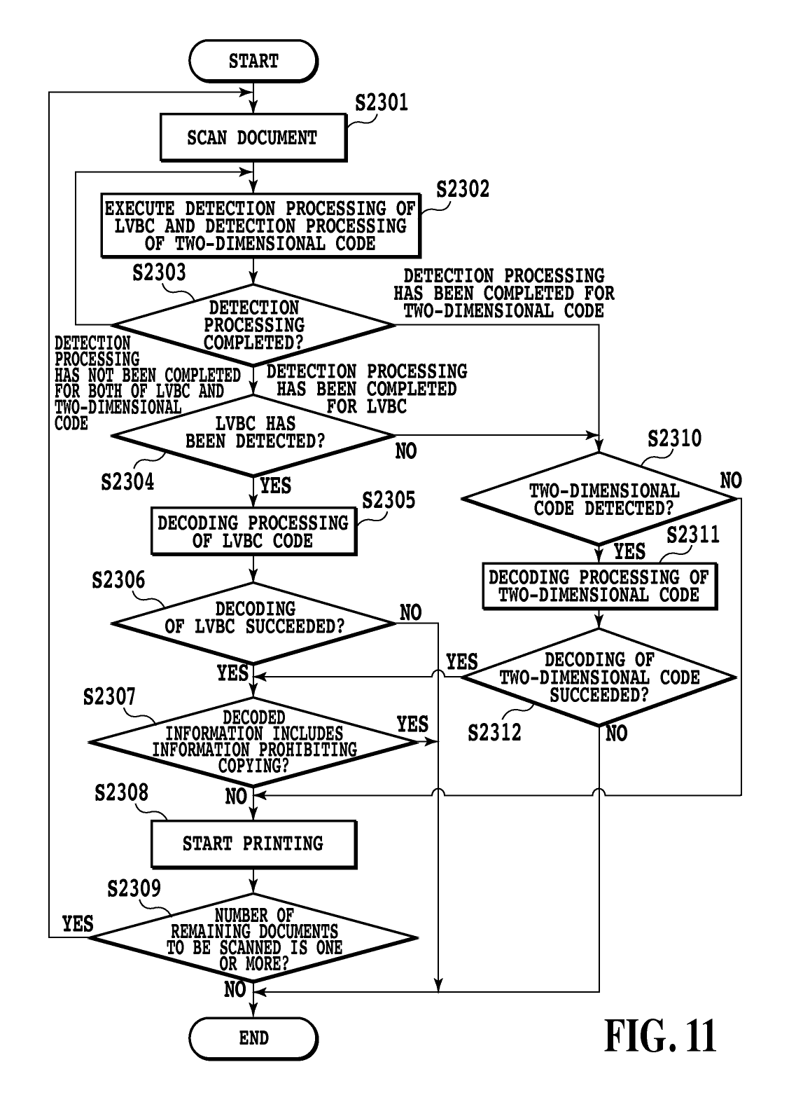

Next, the control of the copy operation carried out by the image processing apparatus 3001, which installs a function of preventing unauthorized copying, will be described using FIG. 5 and FIG. 11.

FIG. 11 is a flowchart showing a flow of the copy control carried out by the image processing apparatus 3001 in the present embodiment.

In Step S2301, the operation unit 3201 receives a copy start instruction from the user. Then, the scanner unit 3202 reads the document by scanning and sends the read document image data to the LVBC extraction processing unit 3309 and the two-dimensional code extraction processing unit 3310 via the scanner I/F 3311 and the scanner image processing unit 3312. Note that, at this time, the scanner image processing unit 3312, when having received the document image data, starts to execute the image processing (e.g., half-toning or the like) needed for the printing of the document image data by the printer unit 3203.

Next, in Step S2302, the LVBC extraction processing unit 3309 executes processing of detecting the LVBC from the document image data, and the two-dimensional extraction processing unit 3310 executes processing of detecting the two-dimensional code from the document image data.

Next, in Step S2303, the job control unit 3320 makes inquiries about whether the detection processing executed in Step S2303 has been completed or not to the LVBC extraction processing unit 3309 and the two-dimensional code extraction processing unit 3310. If the detection processing has not been completed for both of the LVBC and the two-dimensional code, the process goes to Step S2302.

Note that, in the detection processing executed in Step S2302 by the LVBC extraction processing unit 3309, the determination whether the LVBC is embedded or not in the document image data is carried out by determining whether dot analysis is possible or not. That is, if the dot analysis is possible, it is determined that the LVBC is embedded in the document image data. On the other hand, if the dot analysis is not possible, it is determined that the LVBC is not embedded in the document image data. Here, the dot analysis is an analysis of finding a dot, the size of which is equal to or larger than a predetermined size and equal to or smaller than a predetermined size, from among the various dots existing on the printed material.

In Step S2303, if the LVBC extraction processing unit 3309 has completed the detection processing of the LVBC, the process goes to Step S2304.

in Step S2303, if the two-dimensional code extraction processing unit 3310 has completed the detection processing of the two-dimensional code, the process goes to Step S2310.

In Step S2304, if the LVBC extraction processing unit 3309 determines that the LVBC is embedded in the document image data, the process goes to Step S2305.

In Step S2304, if the LVBC extraction processing unit 3309 determines that the LVBC is not embedded in the document image data, the process goes to Step S2310.

In Step S2305, the LVBC extraction processing unit 3309 executes the decoding processing for the LVBC detected from the document image data. After the decoding processing has been completed in Step S2305, the process goes to Step S2306.

In Step S2306, the job control unit 3320 determines whether the LVBC extraction processing unit 3309 has succeeded in the decoding processing to take out the additional information from the LVBC.

In Step S2306, if the decoding of the LVBC has failed and the additional information has not been taken out, the process is terminated.

On the other hand, in Step S2306, if the decoding of the LVBC has succeeded and the additional information has been taken out, the process goes to Step S2307.

In Step S2306, if the decoding of the LVBC has failed in the LVBC extraction processing unit 3309, the job control unit 3320 determines interruption of the copy operation, because there is a possibility that the additional information prohibiting the copying is embedded in the LVBC. Then, the job control unit 3320 cancels the job and thereby interrupts the copy operation of the printer unit 3203. At this time, the job control unit 3320 displays the dialog box 41 shown in FIG. 14 on the operation unit 3201 and notifies the user of the interruption of the printing.

In Step S2307, the LVBC extraction processing unit 3309 determines whether the information prohibiting the copying has been included or not in the additional information decoded and taken out from the LVBC. If the information prohibiting the copying is determined not to be included in the additional information, the process goes to Step S2308.

In Step S2307, if the LVBC extraction processing unit 3309 determines that the information prohibiting the copying is included in the additional information decoded and taken out, the job control unit 3320 determines to interrupt the copy operation. Then, the job control unit 3320 cancels the job and thereby interrupts the copy operation of the printer unit 3203. At this time, the job control unit 3320 displays the dialog box 41 shown in FIG. 14 on the operation unit 3201 and notifies the user of the interruption of the copying.

In Step S2308, the job control unit 3320 sends the print start order of the document image data to the printer unit 3203.

When the printer unit 3203 has already received the document image data from the scanner image processing unit 3312, the printer unit 3203 starts the printing of the document image data.

On the other hand, when the printer unit 3203 has not received the document image data from the scanner image processing unit 3312, the printer unit 3203 waits until the image processing is completed in the scanner image processing unit 3312. Then, the printer unit 3203 starts the printing of the document image data, after having received the document image data from the scanner image processing unit 3312.

Here, the following processing may be carried out for the case that the detection and decoding processing of the LVBC has been completed and the printer unit 3203 starts the printing of the image scanned by the scanner unit 3202 even if the detection and decoding processing of the two-dimensional code has not been completed. That is, the two-dimensional code extraction processing unit 3310 may interrupt the detection and decoding processing of the two-dimensional code.

In Step S2309, the job control unit 3320 determines whether or not the number of the remaining documents to be scanned by the scanner unit 3202 is one or more.

In Step S2309, if the number of the remaining documents to be scanned by the scanner unit 3202 is determined not to be one or more, the process is terminated.

On the other hand, in Step S2309, if the number of the remaining documents to be scanned by the scanner unit 3202 is determined to be one or more, the process goes to Step S2301.

In Step S2310, if the two-dimensional code extraction processing unit 3310 determines that the two-dimensional code is embedded in the document image data, the process goes to Step S2311.

In Step S2310, if the two-dimensional code extraction processing unit 3310 determines that the two-dimensional code is not embedded in the document image data, the process goes to Step S2308.

In Step S2311, the two-dimensional code extraction processing unit 3310 executes the decoding processing for the two-dimensional code detected from the document image data. After the decoding processing has been completed, the process goes to Step S2312.

In Step S2312, the job control unit 3320 determines whether the two-dimensional code extraction processing unit 3310 has succeeded in the decoding processing to take out the additional information from the two-dimensional code. In Step S2312, if it is determined that the two dimensional code has been able to be taken out and the decoding has succeeded, the process goes to Step S2307.

In Step S2312, if it is determined that the two-dimensional code extraction processing unit 3310 has failed in the decoding processing, the job control unit 3320 determines the interruption of the copy operation, because there is a possibility that the additional information prohibiting the copying is embedded in the LVBC. Then, the job control unit 3320 cancels the job and thereby interrupts the copy operation of the printer unit 3203. At this time, the job control unit 3320 displays the dialog box 41 shown in FIG. 14 on the operation unit 3201 and notifies the user of the interruption of the printing.

As described above, in the present embodiment, the following processing is carried out for the case that the detection and decoding processing of the code is carried out in parallel in the LVBC extraction processing unit 3309 and the two-dimensional code extraction processing unit 3310. That is, when the LVBC extraction processing unit 3309 has completed the processing, the process goes to the next step even if the two-dimensional code processing has not been completed. That is, even if the two-dimensional code processing has not been completed, the printing of the image scanned by the scanner unit 3202 starts according to the result of the detection and decoding processing of the code by the LVBC extraction processing unit 3209.

Accordingly, when the detection and decoding processing of the LVBC has been completed before the detection and decoding processing of the two-dimensional code, the process goes to the next step without being affected by the two-dimensional code processing, and thereby it is possible to efficiently carry out the processing of the code.

### Embodiment 2

Next, Embodiment 2 will be described.

Embodiment 1 described above assumes that the detection and decoding processing of the LVBC is completed before the detection and decoding processing of the two-dimensional code.

Such a case is considered to occur when the LVBC extraction processing unit 3309 shown in FIG. 5 executes the detection and decoding processing of the LVBC in a high speed on the hardware (hardware decoder) such as the FPGA, ASIC, or PPC, for example. In addition, it is also considered in this case that the two-dimensional code extraction processing unit 3310 executes the detection and decoding processing of the two-dimensional code by the software (software decoder) on the CPU 3400, for example.

On the other hand, Embodiment 2 assumes the case that the two-dimensional code extraction processing unit 3310 also executes the processing in a high speed on the hardware (hardware decode) such as the FPGA, ASIC, or PPC as same as the LVBC extraction processing unit 3309 in Embodiment 1.

In this case, when the detection and decoding processing of the LVBC and the detection and decoding processing of the two-dimensional code are carried out in parallel, the following case occurs if the additional information embedded in the two-dimensional code has a small information amount. That is, there is a case in which the detection and decoding processing of the two-dimensional code is completed before the detection and decoding processing of the LVBC.

However, in the case of the two-dimensional code which can be cut and pasted and has the weak falsification resistance, another two-dimensional code can be pasted from the above.

For example, to the document having the added LVBC which includes the additional information “prohibit copying”, the two-dimensional code including the additional information indicating “permit copying” can be pasted from the above.

When the detection and decoding processing of the two-dimensional code is completed for this document before the detection and decoding processing of the LVBC, the copying may be executed. The present embodiment assumes this falsification of the two-dimensional code and aims for preventing a false detection when the two-dimensional code is falsified.

In the present embodiment, when the detection and decoding processing of the LVBC, which can be printed over the whole area and has the strong falsification resistance, is completed before the detection and decoding processing of the two-dimensional code, the same control as that in Embodiment 1 is carried out.

When the detection and decoding processing of the two-dimensional code, which has the weak falsification resistance, is completed before the detection and decoding processing of the LVBC, the present embodiment does not execute the copying and always carries out the complete detection and decoding processing of the LVBC, in addition to the control of Embodiment 1.

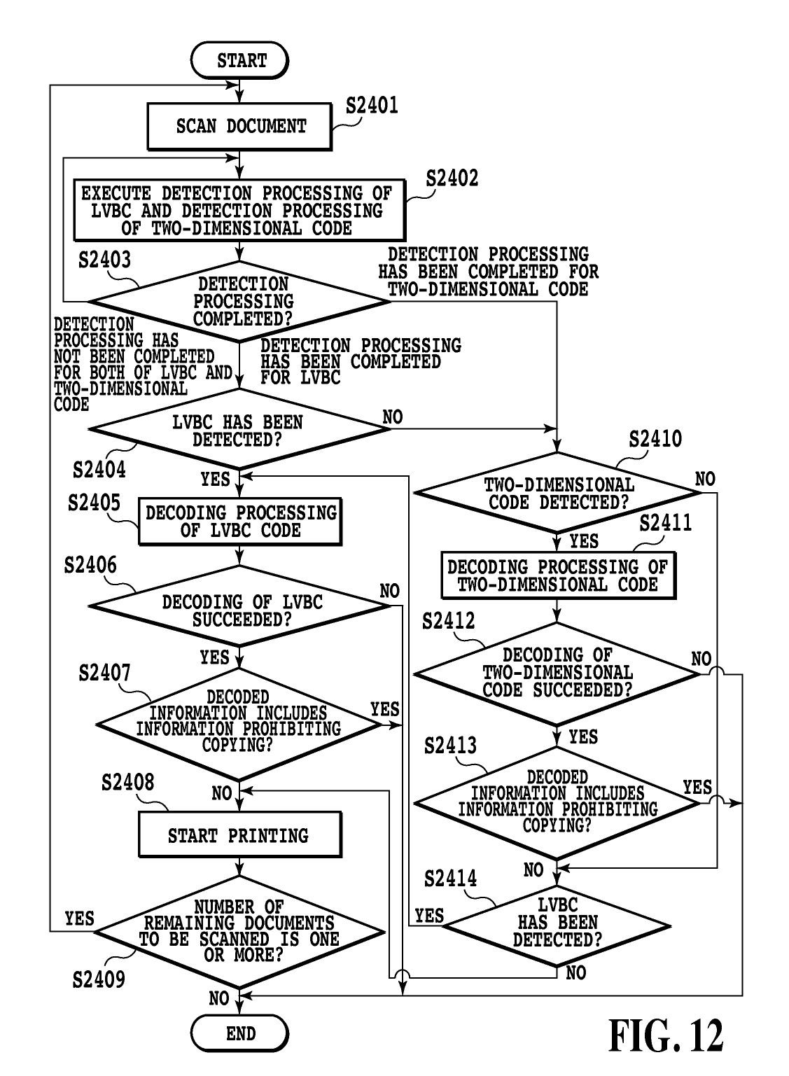

FIG. 12 is a flowchart showing a flow of the copy control executed by the image processing apparatus 3001 in the present embodiment.

In the flowchart shown in FIG. 12, differently from the flowchart of Embodiment 1 shown in FIG. 11, the process movements after the determinations of Step S2410 and Step S2412 are changed, and Step S2413 and Step S2414 are further added.

First, in Step S2401, the operation unit 3201 receives the copy start instruction from the user. Then, the scanner unit 3202 reads the document by scanning and sends the read document image data to the LVBC extraction processing unit 3309 and the two-dimensional code extraction processing unit 3310 via the scanner I/F 3311 and the scanner image processing unit 3312. Note that, at this time, the scanner image processing unit 3312, when having receive the document image data, starts to execute the image processing (e.g., half-toning or the like) necessary for the printing of the document image data in the printer unit 3203.

Next, in Step S2402, the LVBC extraction processing unit 3309 executes the processing to detect the LVBC from the document image data, and the two-dimensional code extraction processing unit 3310 executes the processing to detect the two-dimensional code from the document image data.

Next, in Step S2403, the job control unit 3320 makes inquiries about whether the detection processing executed in Step S2402 has been completed or not to the LVBC extraction processing unit 3309 and the two-dimensional code extraction processing unit 3310. If the detection processing has not been completed for both of the LVBC and the two-dimensional code, the process goes to Step S2402.

Note that, in the detection processing executed in Step S2402 by the LVBC extraction processing unit 3309, the determination whether the LVBC is embedded in the document image data or not is carried out by determining whether dot analysis is possible or not. That is, if the dot analysis is possible, the LVBC is determined to be embedded in the document image data. On the other hand, if the dot analysis is not possible, the LVBC is determined not to be embedded in the document image data. Here, the dot analysis is an analysis to find a dot which has a size equal to or larger than a predetermined size and equal to or smaller than a predetermined size.

In Step S2403, if the LVBC extraction processing unit 3309 has completed the detection processing of the LVBC, the process goes to Step S2404.

In Step S2403, if the two-dimensional code extraction processing unit 3310 has completed the detection processing of the two-dimensional code, the process goes to Step S2410.

In Step S2404, if the LVBC extraction processing unit 3309 determines that the LVBC is embedded in the document image data, the process goes to Step S2405.

In Step S2404, if the LVBC extraction processing unit 3309 determines that the LVBC is not embedded in the document image data, the process goes to Step S2410.

In Step S2405, the LVBC extraction processing unit 3309 carries out the decoding processing for the LVBC detected from the document image data. After the decoding processing has been completed in Step S2405, the process goes to Step S2406.

In Step S2406, the job control unit 3320 determines whether the LVBC extraction processing unit 3309 has succeeded in the decoding processing to take out the additional information from the LVBC.

In Step S2406, if the decoding of the LVBC has failed and the additional information has not been taken out, the process is terminated.

On the other hand, in Step S2406, if the decoding of the LVBC has succeeded and the additional information has been taken out, the process goes to Step S2407.

In Step S2406, if the LVBC extraction processing unit 3309 has failed in the decoding processing, the job control unit 3320 determines to interrupt the copy operation, because there is a possibility that the additional information prohibiting the copying is embedded in the LVBC. Then, the job control unit 3320 cancels the job and thereby interrupts the copy operation of the printer unit 3203. At this time, the job control unit 3320 displays the dialog box 41 shown in FIG. 14 on the operation unit 3201, and notifies the user of the interruption of the printing.

In Step S2407, the LVBC extraction processing unit 3309 determines whether the information prohibiting the copying is included or not in the additional information decoded and taken out from the LVBC. If the information prohibiting the copying is not included in the additional information, the process goes to Step S2408.

In Step S2407, if the LVBC extraction processing unit 3309 determines that the information prohibiting the copying is included in the decoded and taken-out additional information, the job control unit 3320 determines the interruption of the copy operation. Then, the job control unit 3320 cancels the job and thereby interrupts the copy operation of the printer unit 3203. At this time, the job control unit 3320 displays the dialog box 41 shown in FIG. 14, and notifies the user of the interruption of the printing.

In Step S2408, the job control unit 3320 sends a print start order of the document image data to the printer unit 3203.

The printer unit 3203, when having already received the document image data from the scanner image processing unit 3312, starts printing of the document image data.

On the other hand, when the printer unit 3203 has not received the document image data from the scanner image processing unit 3312, the printer unit 3203 starts printing of the document image data after having received the document image data from the scanner image processing unit 3312.

In Step S2409, the job control unit 3320 determines whether or not the number of the remaining documents to be scanned by the scanner unit 3202 is one or more.

In Step S2409, if it is determined that the number of the remaining documents to be scanned by the scanner unit 3202 is not one or more, the process is terminated.

On the other hand, in Step S2409, if it is determined that the number of the remaining documents to be scanned by the scanner unit 3202 is one or more, the process goes to Step S2301.

In Step S2410, if the two-dimensional code extraction processing unit 3310 determines that the two-dimensional code is embedded in the document image data, the process goes to Step S2411.

In Step S2410, if the two-dimensional code extraction processing unit 3310 determines that the two-dimensional code is not embedded in the document image data, the process goes to Step S2414.

In Step S2411, the two-dimensional code extraction processing unit 3310 carries out the decoding processing for the two-dimensional code detected from the document image data. After the decoding processing has been completed, the process goes to Step S2412.

In Step S2412, the job control unit 3320 determines whether the two-dimensional code extraction processing unit 3310 has succeeded in the decoding processing to take out the additional information from the two-dimensional code. In Step S2412, if it is determined that the additional information has been taken out from the two-dimensional code and the decoding has succeeded, the process goes to Step S2413.

In Step S2412, if it is determined that the two-dimensional code extraction processing unit 3310 has failed in the decoding processing, the job control unit 3320 determines to interrupt the copy operation, because there is a possibility that the additional information prohibiting the copying is embedded in the two-dimensional code. Then, the job control unit 3320 cancels the job and thereby interrupts the copy operation of the printer unit 3203. At this time, the job control unit 3320 displays the dialog box 41 shown in FIG. 14 on the operation unit 3201, and notifies the user of the interruption of the printing.

In Step S2413, the two-dimensional code extraction processing unit 3310 determines whether the information prohibiting the copying is included in the additional information which is decoded and taken out from the two-dimensional code. Even if the information prohibiting the copying is not included in the additional information, the process goes to Step S2414 for carrying out the copy control based on the additional information in the LVBC, because the two-dimensional code has the weak falsification resistance.

In Step S2413, if the information prohibiting the copying is included in the additional information which is decoded and taken out from the two-dimensional code by the two-dimensional code extraction processing unit 3310, the job control unit 3320 determines the interruption of the copy operation. Then, the job control unit 3320 cancels the job and thereby interrupts the copy operation of the printer unit 3203.

In Step S2414, if the LVBC extraction processing unit 3309 determines that the LVBC is embedded in the document image data, the process goes to Step S2405.

In Step S2414, if the LVBC extraction processing unit 3309 determines that the LVBC is not embedded in the document image data, the process goes to Step S2408.

In this manner, according to the present embodiment, the following is possible for the case that the detection and decoding processing of the LVBC and the detection and decoding processing of the two-dimensional code are carried out in parallel. That is, when the processing of the LVBC is completed before the processing of the two-dimensional code, the process can go to the next step without being affected by the processing of the two-dimensional code.

Further, according to the present embodiment, in the case that the processing of the two-dimensional code is completed before the processing of the LVBC, it is possible to prevent the false detection when the two-dimensional code is falsified, by detecting and decoding not only the two-dimensional code but also the LVBC.

In the present invention, when the detection and decoding processing of the LVBC has been completed, for example, the printer unit 3203 starts the printing of the image scanned by the scanner unit 3202 in the following case, even if the detection and decoding processing of the two-dimensional code has not been completed.

That is, the printing of the image scanned by the scanner unit 3202 may be started only in the case that the information indicating the printing (copying) permission of the image scanned by the scanner unit 3202 is obtained from the result in the detection and decoding processing of the LVBC.

Accordingly, the printing of the image scanned by the scanner unit 3202 is not started in the case that the information indicating the printing (copying) prohibition of the image scanned by the scanner unit 3202 is obtained from the result in the detection and decoding processing of the LVBC.

Further, in the present invention, for the case which does not meet both conditions that the LVBC has the strong falsification resistance and that the two-dimensional code has the weak falsification resistance, the image processing apparatus may be set as follows. That is, when the detection and decoding processing of the LVBC is completed, the image processing apparatus may be set such that the printing of the image scanned by the scanner unit 3202 is not started by the printer unit 3203 if the detection and decoding processing of the two-dimensional code has not been completed.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2008-231414, filed Sep. 9, 2008, and 2009-090172, filed in Apr. 2, 2009, which are hereby incorporated by reference herein in their entirety.

1. An information processing apparatus comprising:
a control unit that control a printing unit to print at least one of (i) a first code that can include copy permission information alone or the copy permission information together with copy prohibition information, and (ii) a second code that can include only the copy prohibition information
wherein the copy prohibition information is included in the first code when the first code is printed together with the second code by the printing unit.

2. An apparatus, comprising:
a first detection unit that detects a first code from scanned image data;
a second detection unit that detects a second code different from the first code, from the scanned image data; and
a copy permission determination unit that receives detection results from said first detection unit and said second detection unit,
wherein said first detection unit and said second detection unit carry out detection in parallel.

3. The apparatus according to claim 2, wherein said determination unit determines whether copying is permitted or prohibited based on the first completed detection between the detection in said first detection unit and the detection in said second detection unit.

4. An information processing method comprising:
controlling a printing unit to print at least one of (i) a first code that can include copy permission information alone or the copy permission information together with copy prohibition information, and (ii) a second code that can include only the copy prohibition information,
wherein the copy prohibition information is included in the first code when the first code is printed together with the second code by the printing unit.

5. A program recordable in a computer readable storage medium, causing a computer to execute an information processing method comprising: controlling a printing unit to print at least one of (i) a first code that can include copy permission information alone or the copy permission information together with copy prohibition information, and (ii) a second code that can include only the copy prohibition information,
wherein the method includes the copy prohibition information in the first code when causing the printing unit to print the first code together with the second code.
